(19) United States
(12) Patent Application Publication
(10) Pub. No.: US 2010/0187262 A1
(43) Pub. Date: Jul. 29, 2010

(54) BLOW MOLDED CONTAINER, DISPENSER AND CLOSURE

(75) Inventors: ARMEL ARCHENY, BOUVESSE-QUIRIEU (FR); GILLES PEREZ, VOURLES (FR)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: GRAHAM PACKAGING COMPANY, L.P., YORK, PA (US)

(21) Appl. No.: 12/759,103

(22) Filed: Apr. 13, 2010

Related U.S. Application Data
(62) Division of application No. 11/232,895, filed on Sep. 23, 2005.

(51) Int. Cl. B65D 37/00; B65D 41/16; B29C 49/42

(52) U.S. Cl. 222/210; 222/212; 264/531; 264/513

(57) ABSTRACT

A method of producing a container, dispenser, and closure comprises blow molding a body comprising a container portion, a dispenser portion, and a closure portion joined together, and separating the closure portion from the container portion and the dispenser portion. A container, dispenser, and closure made according to the method are also disclosed, along with an intermediate product for producing a container, dispenser, and closure.

This Application is a divisional of U.S. patent application Ser. No. 11/232,895, filed Sep. 23, 2005.

### BACKGROUND OF THE INVENTION

1. Field of the Invention

The present invention relates generally to blow molded containers, dispensers, and closures. More specifically, the present invention relates to containers, dispensers, and closures that are simultaneously blow molded.

2. Description of the Related Technology

Containers including a dispenser and a closure are known in the art. According to one type of known construction, the container includes a container body, a dispenser portion that snaps onto or otherwise permanently attaches to the upper portion of the container body, and a closure, such as a cap, that attaches to the assembled container body and dispenser. The container body is typically blow molded, while the dispenser portion and/or the closure are typically injection molded or compression molded. Molding the dispenser portion and/or the closure by injection molding or compression molding, however, can pose difficulties or make it impossible for the dispenser or closure to be of multi-layer construction, which may be desirable depending on the intended contents.

In some instances, the dispenser portion and/or the closure are injection or compression molded in the same mold that the container body is blow molded in. In this situation, the cavities for the dispenser portion and/or the closure are located above the cavity for the container body, along the parting line of the mold halves. This arrangement usually requires the cavities for the dispenser portion and/or the closure to be oriented vertically with respect to the container body (e.g., tilted 90° with respect to their position when applied to the container), disadvantageously increasing the vertical dimension of the mold. This can place limitations on the possible depths and shapes of the closure. Further, injection or compression molding the closure in the same mold that the body is blown in can require undesirably large clamping forces to be applied the mold halves. In addition, dispensers and/or closures made by this type of injection or compression molding process can be very costly.

Therefore, there remains a need in the art for a method of making a container, dispenser, and closure that overcomes the shortcomings of conventional solutions.

### SUMMARY OF THE INVENTION

The present invention relates to a method of producing a container, dispenser, and closure, comprising blow molding a body comprising a container portion, a dispenser portion, and a closure portion joined together, and separating the closure portion from the container portion and the dispenser portion. The step of separating the closure portion from the container portion and the dispenser portion can comprise cutting the body with a trimmer. The method can further include the step of separating the dispenser portion from the container portion. The dispenser portion can include a spout for dispensing contents.

According to one illustrative aspect of the invention, the closure portion can be adapted to snap onto the dispenser portion. Alternatively, the closure portion can be adapted to snap onto the container portion. Additionally or alternatively, the dispenser portion can be adapted to snap onto the container portion.

According to another illustrative aspect of the invention, the body can further comprise a first moil portion disposed between the dispenser portion and the closure portion. Additionally or alternatively, the body can further comprises a second moil portion disposed between the container portion and the dispenser portion.

According to yet another illustrative aspect of the invention, the body can comprise a single layer of material. Alternatively, the body can comprise multiple layers of material.

The present invention also relates to a container, a closure, and a dispenser made by the above-described method.

The present invention further relates to an intermediate product for producing a container, dispenser, and closure, comprising a blow molded plastic body comprising a container portion, a dispenser portion having a spout for dispensing contents, and a closure portion joined together.

Further objectives and advantages, as well as the structure and function of preferred embodiments will become apparent from a consideration of the description, drawings, and examples.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIGS. 1-4 illustrate an exemplary method of producing a container, dispenser, and closure according to the present invention;

FIG. 5 is a rear view of an exemplary embodiment of an intermediate product for producing a container, dispenser, and closure according to the present invention;

FIG. 6 is a side view of an exemplary embodiment of an intermediate product for producing a container, dispenser, and closure according to the present invention;

FIG. 7 is a side view of the intermediate product of FIG. 5, shown with first and second moil portions removed; and

FIG. 8 is a perspective view of an exemplary embodiment of a container, dispenser, and closure according to the present invention, shown with the dispenser attached to the container and the closure detached from the container and dispenser.

### DETAILED DESCRIPTION OF THE PREFERRED EMBODIMENT(S)

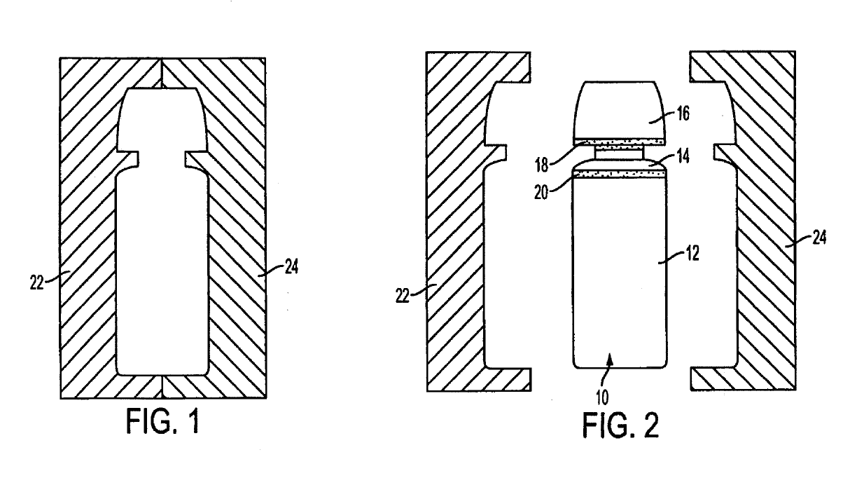

Referring now to the drawings, wherein like reference numerals designate corresponding structure throughout the views, and referring in particular to FIG. 1,

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

Referring to FIGS. 1-4, an exemplary method of producing a container, dispenser, and closure according to the present invention is shown. The method includes blow molding a body 10 which comprises a container portion 12, a dispenser portion 14, and a closure 16 joined together. The body 10 can also include one or more moil portions, such as a first moil portion 18 located between the container portion 12 and the dispenser portion 14, and/or a second moil portion 20 located between the dispenser portion 14 and the closure portion 16. The body 10 can be blow molded in a cavity defined by a pair of mold halves 22, 24 using one of several known blow molding techniques, such as, for example, extrusion blow molding, injection blow molding, or stretch blow molding. According to one exemplary embodiment, the body 10 can be extrusion blow molded by inserting the blow needle (not shown) into one or both of the moil portions 18, 20.

Body 10 can be blow molded from a monolayer plastic material, such as a polyamide, for example, nylon; a polyolefin such as polyethylene, for example, low density polyethylene (LDPE) or high density polyethylene (HDPE), or polypropylene; a polyester, for example polyethylene terephthalate (PET), polyethylene naphtalate (PEN); or others, which can also include additives to vary the physical or chemical properties of the material. For example, some plastic resins can be modified to improve the oxygen permeability. Alternatively, the container can be prepared from a multilayer plastic material. The layers can be any plastic material, including virgin, recycled and reground material, and can include plastics or other materials with additives to improve physical properties of the container. In addition to the above-mentioned materials, other materials often used in multilayer plastic containers include, for example, ethylvinyl alcohol (EVOH) and tie layers or binders to hold together materials that are subject to delamination when used in adjacent layers. A coating may be applied over the monolayer or multilayer material, for example to introduce oxygen barrier properties.

Once the body 10 is blow molded, the mold halves 22, 24 separate to release the body 10 from the mold, as shown in FIG. 2. Next, as shown in FIG. 3, the different portions of body 10 are separated, where necessary. For example, the closure portion 16 can be separated from the container portion 12 and the dispenser portion 14. According to one exemplary embodiment of the invention, the dispenser portion 14 and the container portion 12 can remain joined together, as molded, for final use of the container. Alternatively, the dispenser portion 14 can be separated from the container portion 12 and subsequently reconnected thereto, as will be discussed in more detail below.

In order to separate the different portions of body 10, it can be cut with one or more trimmers, such as a blades, hot knives, hot wires, or other devices, to separate the different portions from one another. In the exemplary embodiment of FIG. 3, a first blade 26 separates the closure portion 16 from the first moil portion 18, a second blade 28 separates the first moil portion 18 from the dispenser portion 14, a third blade 30 separates the dispenser portion 14 from the second moil portion 20, and a fourth blade 32 separates the second moil portion 20 from the container portion 12. The blades 26-32 can act on the body 10 simultaneously, as shown in FIG. 3, or alternatively, can act on the body 10 in separate steps. Alternatively, a single blade can act on body 10 in four different steps. In addition, one of ordinary skill in the art will appreciate that other techniques for separating the different portions of body 10 are possible, and are included within the present invention. For example, the different portions of body 10 can be separated using a laser.

Referring to FIG. 4, once the container portion 12, closure portion 16, and optionally the dispenser portion 14 are separated, the container can be assembled. For example, the dispenser portion 14 can attach to the container portion 12, for example, by mating threads, snap connectors, bonding, or some combination thereof. One of ordinary skill in the art will appreciate that other structures are possible for attaching the dispenser portion 14 to the container portion 12. In the exemplary embodiment shown in FIG. 4, the dispenser portion 14 attaches to the container portion 12 by a snap connection, discussed below in more detail. As discussed above, dispenser portion 14 and container portion 12 may alternatively remain together as an integral unit (i.e., as molded) for use. The closure portion 16 can be removably attached to the assembled container portion 12 and dispenser portion 14, for example, by mating threads or snap connectors. According to one exemplary embodiment shown, the closure portion 16 attaches to the container portion 12. Alternatively, the closure portion 16 can attach to the dispenser portion 14. The optional moil portions 18 and/or 20, if provided, can be discarded or recycled.

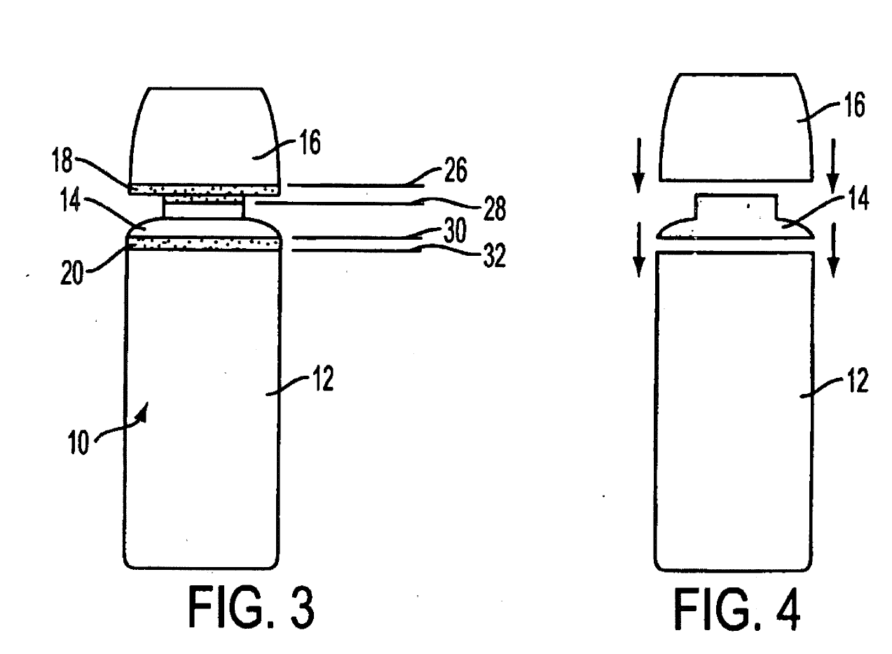

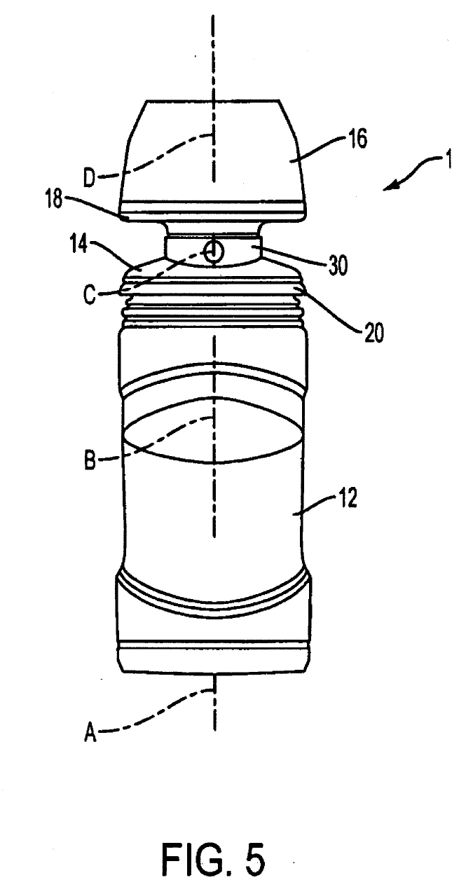

Referring to FIGS. 5 and 6, an exemplary embodiment of body 10 is shown in detail. Body 10 generally defines a central axis A. The container portion 12, dispenser portion 14, and/or closure portion 16 can have a substantially round cross-section in a plane perpendicular to the central axis A, as shown. Alternative cross-sections can include, for example, an oval transverse cross-section, a substantially square transverse cross-section, other substantially polygonal transverse cross-sectional shapes such as triangular, pentagonal, etc., or combinations of curved and arced shapes with linear shapes. As will be understood by one of ordinary skill in the art, when the container has a substantially polygonal transverse cross-section, the corners of the polygon are typically rounded or chamfered.

Still referring to FIGS. 5 and 6, the dispenser portion 14 can include a spout 30 adapted to facilitate dispensing of the contents of the finished container. For example, spout 30 can be adapted to pour liquid, granular, powder, etc. contents from the finished container. Spout 30 may be offset from the central axis A toward the perimeter of the container, as illustrated in FIG. 6. First moil portion 18 may be attached to the dispenser portion 14 at the spout 30, such that separating the first moil portion 18 from the dispenser portion 14 creates the opening in spout 30 for contents to pass through.

Referring to FIG. 5, the container portion 12 can define its own central axis B, the dispenser portion 14 can define its own central axis C, and the closure portion 16 can define its own central axis D. In the exemplary embodiment shown, these axes are collinear with the body central axis A. When the container portion 12, dispenser portion 14, and closure portion 16 are still joined together (i.e., prior to separating them with the trimmer), two, and preferably all three of these axes are substantially parallel to one another (i.e., such that the dispenser portion 14 and/or closure portion 16 are oriented in the position in which they are attached to the container portion 12). This configuration can reduce the overall height of body 10 as compared to prior art configurations, thereby potentially saving valuable space in the molding machine.

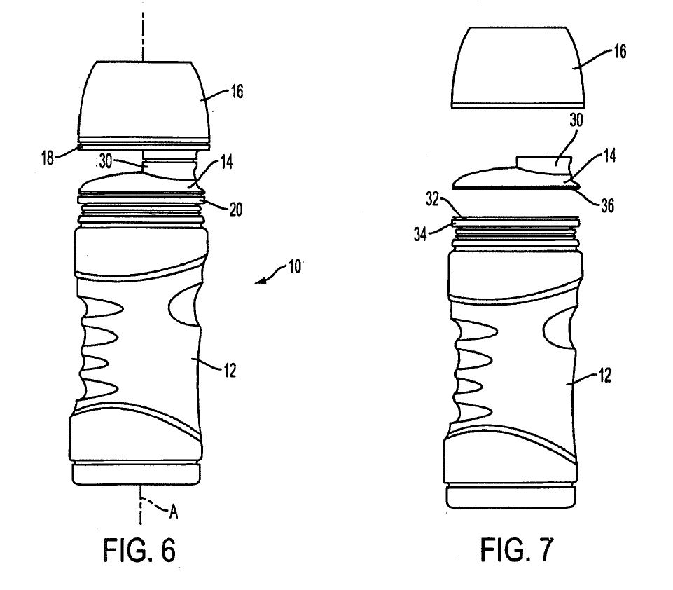

Referring to FIG. 7, the container portion 12, dispenser portion 14, and closure portion 16 are shown with the first and second moil portions 18, 20 removed. The dispenser portion 14 can be adapted to snap onto the container portion 12. For example, the upper rim of container portion 12 can include a ridge 32 immediately above a groove 34. The lower edge 36 of dispenser portion 14 can be slightly recessed inward, such that the lower edge 36 snaps over the ridge 32 and into the groove 34, thereby retaining the dispenser portion 14 on the container portion 14. Additionally or alternatively, the dispenser portion 14 can be bonded or thermo-welded onto the container portion 12. According to an alternative embodiment of the invention, the dispenser portion 14 can be attached to the container portion 12 by mating threads or other known structures. The container portion 12 can be filled with contents prior to attaching the dispenser portion 14, or alternatively, after attaching the dispenser portion 14 (i.e., through the spout 30).

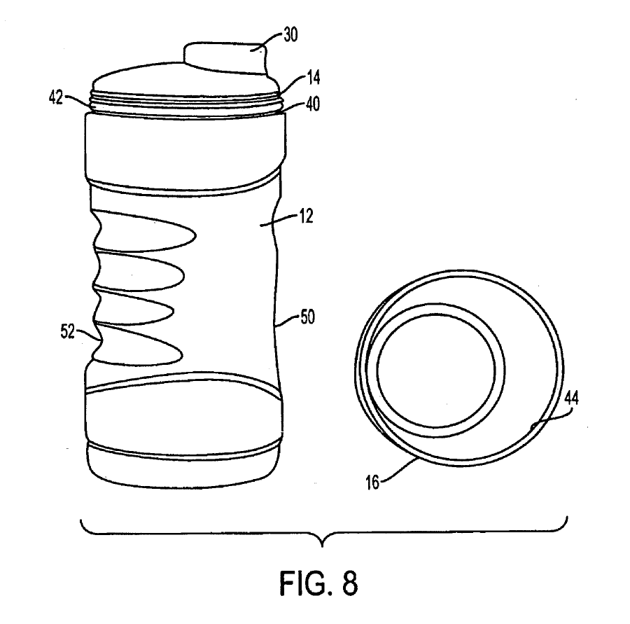

Referring to FIG. 8, the assembled container portion 12 and dispenser portion 14 is shown, with the cover portion 16 detached. The cover portion 16 can snap onto the container portion and/or dispenser portion 14 in order to cover the spout 30, for example, to prevent accidental spillage of contents from the container. Container portion 12 can include a recess 40 defined below a ridge 42, and the lower edge 44 of closure portion 16 can recede inwardly, such that the lower edge 44 slides over the ridge 42 and snaps into the recess 40, thereby retaining the closure portion 16 on the container portion 12. The ridge 42 and recess 40 can alternatively be provided on the dispenser portion 14. Alternatively, the closure portion 16 can be secured to the container portion 12 and/or dispenser portion 14 by mating threads or other types of connectors.

Still referring to FIG. 8, the container according to the present invention can be used to package a wide variety of liquid, viscous or solid products including, for example, juices, other beverages, yogurt, sauces, pudding, lotions, soaps in liquid or gel form, and bead shaped objects such as candy.

The container portion 12 can include various features that improve the appearance, ergonomics, and strength of the container. For example, the exemplary embodiment shown in FIG. 8 includes a recessed panel 50 and a plurality of grips 52. One of ordinary skill in the art will appreciate that numerous other features that improve the appearance, ergonomics, and strength can alternatively or additionally be provided.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A method of producing a container, dispenser, and closure, comprising:
blow molding a body comprising a container portion, a dispenser portion, and a closure portion joined together; and
separating the closure portion from the container portion and the dispenser portion.

2. The method of claim 1, wherein the closure portion is adapted to snap onto the dispenser portion.

3. The method of claim 1, wherein the closure portion is adapted to snap onto the container portion.

4. The method of claim 1, wherein the step of separating the closure portion from the container portion and the dispenser portion comprises cutting the body with a trimmer

5. The method of claim 1, further comprising the step of separating the dispenser portion from the container portion.

6. The method of claim 5, wherein the dispenser portion is adapted to snap onto the container portion.

7. The method of claim 5, wherein the step of separating the dispenser portion from the container portion comprises cutting the body with a trimmer.

8. The method of claim 1, wherein the body further comprises a first moil portion disposed between the dispenser portion and the closure portion.

9. The method of claim 1, wherein the body further comprises a second moil portion disposed between the container portion and the dispenser portion.

10. The method of claim 1, wherein the dispenser portion includes a spout for dispensing contents.

11. The method of claim 1, wherein the body comprises a single layer of material.

12. The method of claim 1, wherein the body comprises multiple layers of material.

13. A container made by the method of claim 1.

14. A closure made by the method of claim 1.

15. A dispenser made by the method of claim 1.
